(19) United States
(12) Patent Application Publication
(10) Pub. No.: US 2017/0225307 A1
(43) Pub. Date: Aug. 10, 2017

(54) Bucket Separating Tool

(71) Applicants: Max Bass, O'Brien, FL (US); Dawn Bass, O'Brien, FL (US)

(72) Inventors: Max Bass, O'Brien, FL (US); Dawn Bass, O'Brien, FL (US)

(21) Appl. No.: 15/425,464

(22) Filed: Feb. 6, 2017

Related U.S. Application Data
(60) Provisional application No. 62/291,688, filed on Feb. 5, 2016.

(51) Int. Cl. B25B 27/14; B25G 1/10

(52) U.S. Cl. CPC B25B 27/14; B25G 1/102

(57) ABSTRACT

A bucket separating tool for removing a first bucket that has been nestled within a second bucket is provided. The bucket separating tool is a T-shaped tool having a horizontal member that is hingedly attached to a vertical member. The horizontal member includes an end having a curved edge configured to engage the lower edge of the lip of a first bucket, which is nestled in a second bucket. The vertical member includes an end having a curved edge configured to securely engage the upper edge of the lip of the second bucket. In operation, a user engages the lips of two stacked buckets with the curved edges and applies a rotational force on the vertical member to separate one bucket from the other.

### CROSS REFERENCE TO RELATED APPLICATIONS

This application claims the benefit of U.S. Provisional Application No. 62/291,688 filed on Feb. 5, 2016. The above identified patent application is herein incorporated by reference in its entirety to provide continuity of disclosure.

### BACKGROUND OF THE INVENTION

The present invention relates to hand tools. More specifically, the present invention relates to a hand tool configured to easily disengage a first bucket that has been nestled within a second bucket.

The usefulness of the ubiquitous bucket is difficult to overemphasize. A bucket can perform duties ranging from storing unused material, assisting in transporting items from one place to another, and acting as a container to mix compounds. A job can often require the use of more than a single bucket, and as a result many individuals will own many buckets. When they are not in use, most buckets are designed to easily nestle within each other to create a single stack. This allows for efficient storage of the unused buckets, as a single stack of buckets will take up significantly less room than the same number of buckets stored individually. However, nestled buckets can often become difficult to separate due to friction between the inner surface of a first bucket and the outer surface of a second bucket. Additionally, residue from a worksite, such as dirt or mixed concrete, can inadvertently become lodged between two stacked buckets. This can make it exceedingly difficult and frustrating to separate one bucket from another. Additionally, the space between two stacked buckets can vary according to the dimensions and design of the buckets. Accordingly, a device designed to easily remove a nestled bucket is desired.

### SUMMARY OF THE INVENTION

In view of the foregoing disadvantages inherent in the known types of hand tools now present in the prior art, the present invention provides a bucket separating tool wherein the same can be utilized for providing convenience for the user when removing a bucket from a stack of buckets. The present system comprises a T-shaped tool having a horizontal member that is hingedly attached to a vertical member. One end of the horizontal member features a curved edge designed to engage an upper edge of a lip of a bucket, and one end of the vertical member features a curved edge that is designed to securely engage with the bottom edge of a lip of a bucket. In operation, a user engages the curved edges with the lips of two stacked bucket and applies a rotational force on the vertical member to easily separate one bucket from another.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1A shows a perspective view the bucket separating tool in a starting position.

FIG. 1B shows perspective view of the bucket separating tool in a rotated position.

FIG. 2 shows a perspective view of an alternative embodiment of the vertical member of the bucket separating tool that is height adjustable.

FIG. 3 shows perspective view of the bucket separating tool in use.

### DETAILED DESCRIPTION OF THE INVENTION

Reference is made herein to the attached drawings. Like reference numerals are used throughout the drawings to depict like or similar elements of the bucket separating tool. The figures are intended for representative purposes only and should not be considered to be limiting in any respect.

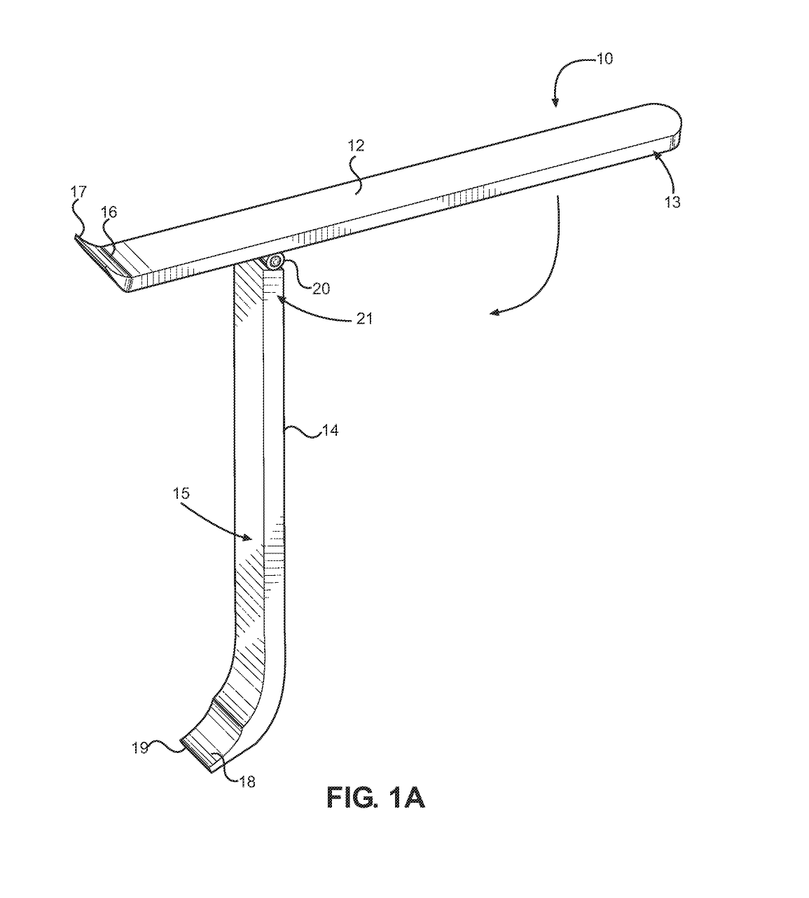

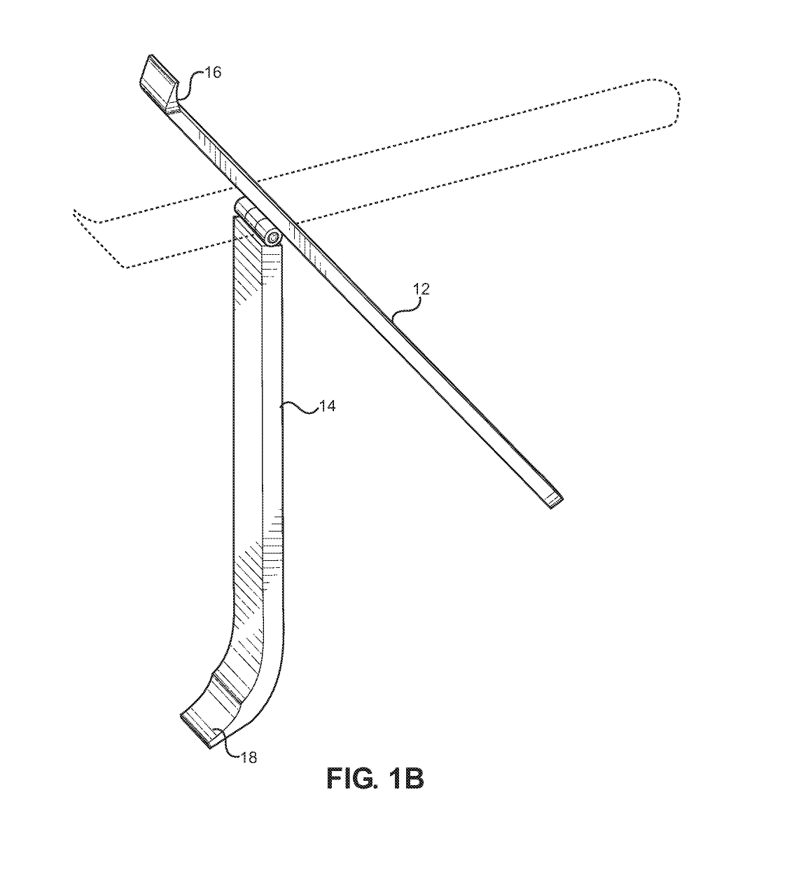

Referring now to FIGS. 1A and 1B, there are shown perspective views the bucket separating tool in a starting position and a rotated position, respectively. The bucket separating tool 10 comprises an elongated vertical member 14 having a proximal end 21 and distal end 18, and an elongated horizontal member 12 having a proximal end 13 and distal end 16. The vertical member 14 is rotatably attached to the horizontal member 12 via a hinge 20. The distal end 16 of the horizontal member 12 curves upward and comprises an upper straight edge 17 configured to engage with the lower side of the lip of a bucket. Similarly, the distal end 18 of the horizontal member 14 curves outward and comprises a lower straight edge 19 configured to engage with the upper side of the lip of a bucket.

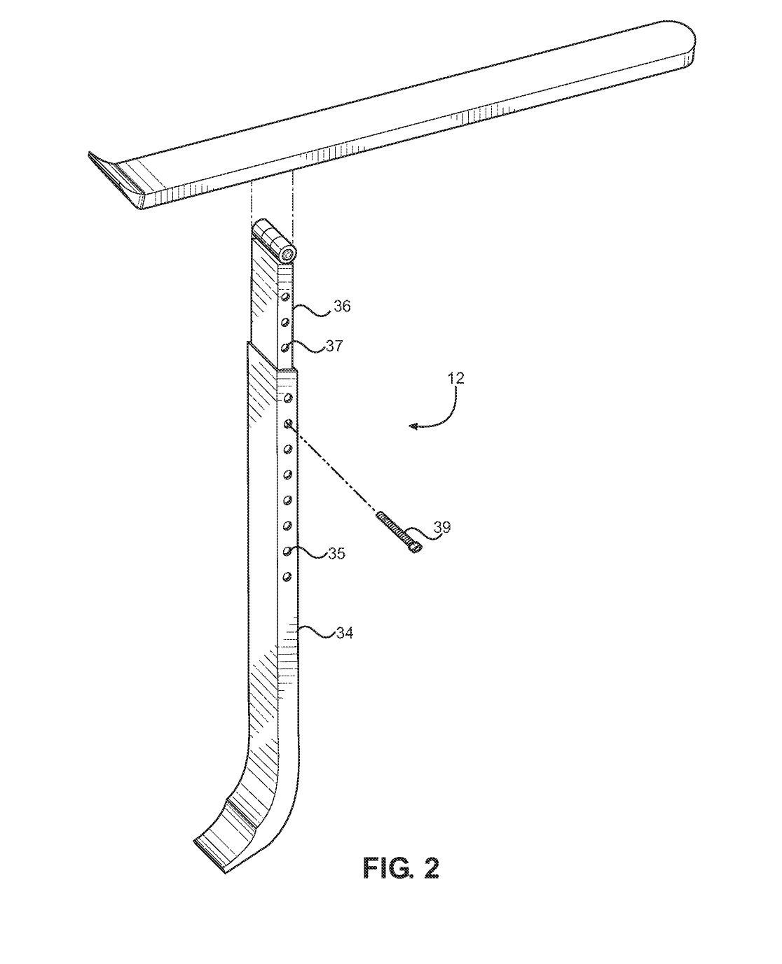

In one embodiment of the bucket separating tool, the hinge 20 is secured to the proximal end 21 of the vertical member 14 and to the horizontal member 12 at an intermediate position therealong forming a T-shape, wherein the intermediate position is closer to the distal end 16 of the horizontal member 12 than to its proximal end 13. The hinge 20 is configured to allow the horizontal member 12 to rotate relative to the vertical member 14, such that the distance between the lower straight edge 19 of the vertical member and the upper straight edge 17 of the horizontal member 12 increases as the horizontal member 12 moves from a starting position (see FIG. 1) to a rotated position (see FIG. 2). In one embodiment of the bucket separating tool 10, there is padding disposed on the proximal end 13 of the horizontal member 12 to provide a comfortable grip for a user when handling the tool 10.

Referring now to FIG. 2, there is shown a perspective view of an alternative embodiment of the vertical member of the bucket separating tool that is height adjustable. One embodiment of the bucket separating tool 10 comprises a vertical member 12 that is height adjustable to accommodate buckets having various differences in heights. Bucket designs may differ such that when stacking two buckets, the distance between a lip of a lower bucket and a lip of an upper bucket may vary. An adjustable vertical member 12 ensures that the bucket separating tool 10 is compatible with a larger range of such bucket height differences than a tool lacking an adjustable feature.

In one embodiment of the height adjustable vertical member 12, the vertical member 12 comprises a hollow lower section 34 and an upper section 36, wherein the upper section 36 is slidably disposed within the hollow interior of lower section 34, thereby forming a telescopic arrangement. The lower section 36 further comprises a locking mechanism configured to secure the upper section 34 in place at a desired height. In the depicted embodiment, the locking mechanism comprises a series of lower apertures 35 disposed along the length of the lower section 34 and a set of corresponding upper apertures 37 disposed along the length of the upper section 36. The upper section 36 is adjusted to a desired height, wherein a locking pin 39 is inserted through both a lower aperture 35 and an upper aperture 37, securing the upper section 36 in place.

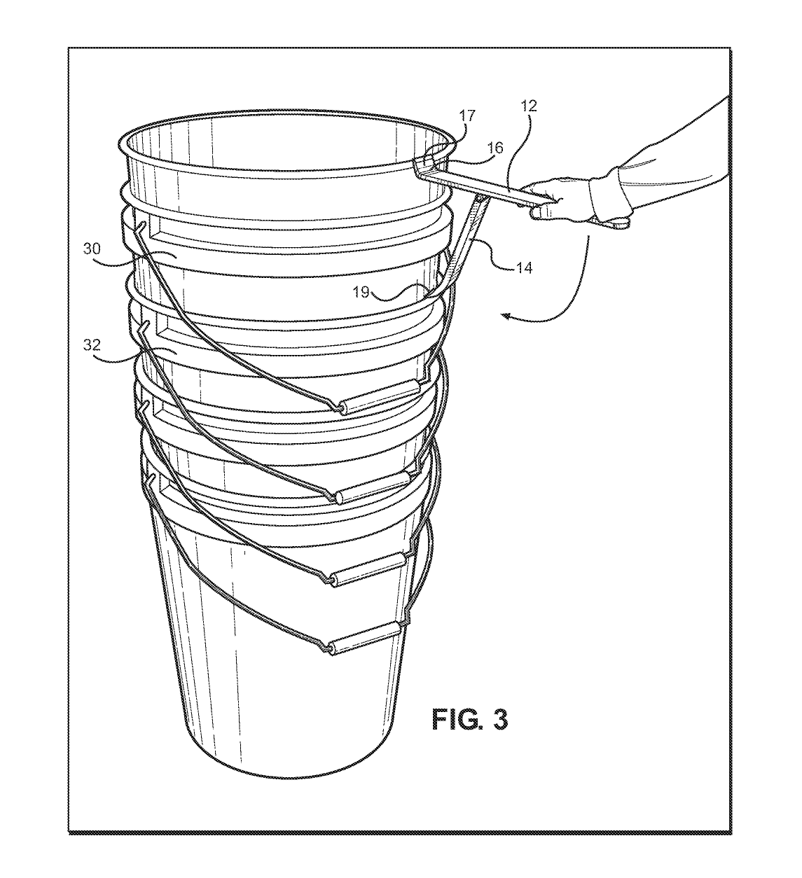

Referring now to FIG. 3, there is shown a perspective view of an embodiment of the bucket separating tool in use. A user rotates the horizontal member 12 to a starting position and places the lower straight edge 19 of the vertical member 14 on the upper side of a lip of a lower bucket 32. The horizontal member 12 is rotated until the upper straight edge 17 of the horizontal member 12 engages with a lower side of a lip of an upper bucket 30. The user then applies a downward force on the proximal end 13 of the horizontal member 12, causing the distal end 16 of the horizontal member 12 to raise, applying an upward force on the upper bucket and causing the upper bucket 30 to separate from the lower bucket 32. Because the hinge 20 is placed closer to the distal end of the horizontal member than the proximal end thereof, the torque applied to the proximal end 13 is amplified on the distal end 16, thus allowing a user to easily separate stacked buckets that may otherwise require more than one person to separate.

It is therefore submitted that the instant invention has been shown and described in various embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A bucket separating tool, comprising:
a vertical member including a distal end and a proximal end, the distal end curving outwardly and including a straight edge;
a horizontal member including a distal end and a proximal end, the distal end curving outwardly and including a straight edge;
wherein the vertical member is hingedly attached to the horizontal member at an intermediate position along the length of the horizontal member.

2) The bucket separating tool of claim 1, wherein the vertical member further comprises height adjustable mechanism.

3) The bucket separating tool of claim 1, wherein the vertical member further comprises an upper section and a hollow lower section, wherein the upper section is slidably disposed within an interior of the hollow lower section, thereby forming a telescopic arrangement.

4) The bucket separating tool of claim 3, wherein the upper section of the vertical member further comprises a plurality of upper apertures disposed longitudinally thereon, and wherein the lower section further comprises a plurality of lower apertures disposed longitudinally thereon, such that the plurality of upper apertures align with the plurality of lower apertures when the upper section is inserted within the lower section.

5) The bucket separating tool of claim 4, further comprising a locking pin that can be removable inserted through one of the plurality lower of apertures and one of the plurality of upper apertures, and configured to secure the upper section in place relative to the lower section.

6) The bucket separating tool of claim 1, wherein the intermediate position is offset relative to a center of the horizontal member, such that the intermediate position is disposed between the distal end and the center of the horizontal member.
